(19) United States
(12) Patent Application Publication
(10) Pub. No.: US 2004/0079888 A1
(43) Pub. Date: Apr. 29, 2004

(54) Infrared detection device

(75) Inventor: Shuji Inamura, Tokyo (JP)

Correspondence Address: McDERMOTT, WILL & EMERY, 600 13th Street, N.W., Washington, DC, 20005-3096, US

(73) Assignee: Ishizuka Electronics Corp.

(21) Appl. No.: 10/347,455

(22) Filed: Jan. 21, 2003

(30) Foreign Application Priority Data
Oct. 28, 2002 (JP) 2002-312674

(51) Int. Cl. G01J 5/02

(52) U.S. Cl. 250/353; 250/338.1

(57) ABSTRACT

A precision infrared detection device is provided, which is capable of measuring a wide range of temperature having a simple constitution, reduces the influence due to the dispersion among the operating points, and enables the cost down. The infrared detection device includes: reference voltage generation means 101 for generating a specific reference voltage; ambient temperature compensation means 102, to which a reference voltage from the reference voltage generation means 101 is applied, for outputting a signal for compensating the ambient temperature; first amplification means 103 for amplifying the signal outputted from the ambient temperature compensation means 102; infrared detection means 104, to which a signal outputted from the first amplification means 103 is applied, for converting infrared radiation energy into an electric signal; and second amplification means 105 for amplifying a signal outputted from the infrared detection means 104.

### BACKGROUND OF THE INVENTION

(1) Field of the Invention

The present invention relates to an infrared detection device.

(2) Description of the Related Art

An example of a conventional infrared detection device is disclosed in Japanese Patent Application Laid-Open No. H9-505434.

FIG. 7 shows a block diagram of the conventional infrared detection device as mentioned above. In FIG. 7, the infrared detection device includes a concave mirror 3. A sensor element 4 is arranged at a focal point of the concave mirror 3. An output signal from the sensor element 4 is compared with a reference signal and converted to a temperature signal in an evaluation circuit 15. The sensor element 4 includes a thermopile 6, in the vicinity of which a temperature reference element 5 is arranged. A first pre-amplifier 8, 9 capable of calibration amplifies an output signal from the thermopile 6, while a second pre-amplifier 10, 11, 12, 13 amplifies an output signal from the temperature reference element 5. A third pre-amplifier 14 is connected thereto as a differential amplifier 14, which constitutes a pre-amplifier amplifying the difference between the output signal from the first pre-amplifier 8, 9 and that from the second pre-amplifier 10, 11, 12, 13.

In the infrared detection device constructed as described above, when the thermopile 6 receives infrared radiated from a measuring object having a temperature lower than that of a receiving portion of the thermopile 6, the polarity of the output from the thermopile 6 is reversed. A negative output voltage is inputted from the thermopile 6 to the first pre-amplifier 9 and a negative output voltage is outputted from the first pre-amplifier 9. However, when the thermopile 6 receives infrared radiated from a measuring object having a temperature lower than that of a receiving portion of the thermopile 6 by a certain degrees, the first pre-amplifier 9 has a characteristic of outputting a constant negative voltage, therefore, an output voltage corresponding to the temperature of the measuring object is not outputted. Consequently, the conventional infrared detection device as described above has not been capable of measuring a wide range of temperature.

Moreover, since the conventional infrared detection device employs three pre-amplifiers, the dispersion among the three operating points are combined and outputted from the third pre-amplifier 14, therefore the accurate temperature measurement has been difficult. Furthermore, since the conventional infrared detection device employs three pre-amplifiers, therefore it has been difficult to prevent the cost from rising.

### SUMMARY OF THE INVENTION

It is therefore an objective of the present invention to solve the above problems and to provide a precision infrared detection device, which is capable of measuring a wide range of temperature having a simple constitution, reduces the influence due to the dispersion among the operating points, and enables the cost down.

In order to attain the above objective, the present invention is to provide an infrared detection device comprising:

reference voltage generation means for generating a specific reference voltage;

ambient temperature compensation means, to which a reference voltage from the reference voltage generation means is applied, for outputting a signal for compensating the ambient temperature;

first amplification means for amplifying the signal outputted from the ambient temperature compensation means;

infrared detection means, to which a signal outputted from the first amplification means is applied, for converting infrared radiation energy into an electric signal; and

second amplification means for amplifying a signal outputted from the infrared detection means.

With the construction described above, the infrared detection device enables temperature measurement for a wide range of temperature with a constitution simpler than that of a conventional device, reduces the influence due to the dispersion among the operating points, and enables the cost down.

Preferably, the ambient temperature compensation means comprises a thermistor for detecting the ambient temperature.

With the construction described above, the variation in the ambient temperature is detected as the variation in an electrical resistance, which is converted into the variation in voltage so that a signal for temperature compensation can be outputted.

Preferably, the ambient temperature compensation means further comprises linearization means for linearizing a temperature characteristic of the thermistor for detecting the ambient temperature.

With the construction described above, the infrared detection device enables precision temperature compensation.

Preferably, the infrared detection means is a thermopile.

With the construction described above, infrared can be detected with high sensitivity.

Preferably, the first and second amplification means include their respective operational amplifiers.

With the construction described above, precision infrared detection can be attained by suitably setting the gain of the respective operational amplifiers.

Preferably, the infrared detection device further comprises condensing means for condensing infrared radiated from a measuring object and guiding the condensed infrared to the infrared detection means.

With the construction described above, efficient infrared detection can be attained.

Preferably, the condensing means is an infrared reflector comprising:

a concave mirror;

a recess in which an infrared sensor including the thermistor for detecting the ambient temperature and the thermopile is placed; and

an opening formed facing the concave mirror, which guides the infrared radiated from a measuring object to the concave mirror, wherein the infrared sensor is arranged so that an infrared-receiving section of the thermopile is situated at a focal point of the concave mirror.

With the construction described above, the radiated infrared is efficiently guided to the infrared-receiving section of the thermopile by the concave mirror, thereby enabling infrared detection with high sensitivity.

### BRIEF DESCRIPTION OF THE DRAWINGS

FIG. 1 is a circuit diagram illustrating a basic constitution of a preferred embodiment of an infrared detection device according to the present invention;

FIG. 2 is an exploded perspective view illustrating an example of an infrared sensor in an infrared detection device according to the present invention;

FIG. 3 is a cross section illustrating an example of an infrared sensor module in an infrared detection device according to the present invention;

FIG. 4 is a graph illustrating an output voltage characteristic of a temperature compensation circuit in an infrared detection device according to the present invention;

FIG. 5 is a temperature characteristic graph illustrating temperature compensation of a thermopile in an infrared detection device according to the present invention;

FIG. 6 is a circuit diagram illustrating an example of an actual constitution of an infrared detection device according to the present invention; and

FIG. 7 is a circuit diagram illustrating an example of a conventional infrared detection device.

### DESCRIPTION OF THE PREFERRED EMBODIMENTS

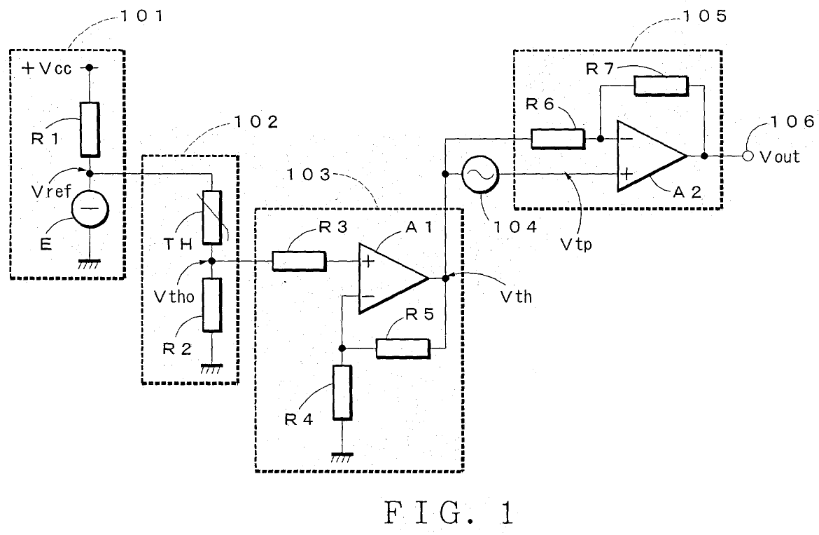

In the following, the preferred embodiments of the present invention will be explained with reference to the attached drawings. FIG. 1 is a circuit diagram illustrating a basic constitution of a preferred embodiment of an infrared detection device according to the present invention. As shown in FIG. 1, the infrared detection device includes a reference voltage generation circuit 101, temperature compensation circuit 102, first amplifier 103, thermopile 104, second amplifier 105, and output terminal 106.

The reference voltage generation circuit 101, acting as the reference voltage generation means, includes a resistance R1 connected in series to +Vcc and reference voltage source E.

The temperature compensation circuit 102, acting as the ambient temperature compensation means, includes a thermistor TH for detecting the ambient temperature and a resistance R2, which are connected in series to between a connecting point of the resistance R1 and the reference voltage source E in the reference voltage generation circuit 101 and ground.

The first amplifier 103 includes an operational amplifier A1 and resistances R3, R4 and R5. The resistance R3 is connected to between a connecting point of the thermistor TH and resistance R2 in the temperature compensation circuit 102 and a non-inverting input terminal of the operational amplifier A1. The resistance R4 is connected to between the inverting input terminal of the operational amplifier A1 and ground. The resistance R5 is connected to between the inverting input terminal of the operational amplifier A1 and an output terminal thereof.

The second amplifier 105 includes an operational amplifier A2 and resistances R6 and R7. The resistance R6 is connected to between the output terminal of the operational amplifier A1 and an inverting input terminal of the operational amplifier A2. The resistance R7 is connected to between the inverting input terminal of the operational amplifier A2 and an output terminal thereof.

The thermopile 104, acting as the infrared detection means, is connected to between the output terminal of the operational amplifier A1 and a non-inverting input terminal of the operational amplifier A2.

As shown in FIG. 2, the thermopile 104 and the thermistor TH for detecting the ambient temperature is built in an infrared sensor S, in which the thermopile 104 and the thermistor TH are mounted on a stem 110 and connected to lead terminals 111. The stem 110 is covered with a cap 112, on which an infrared-transparent filter 113 is mounted.

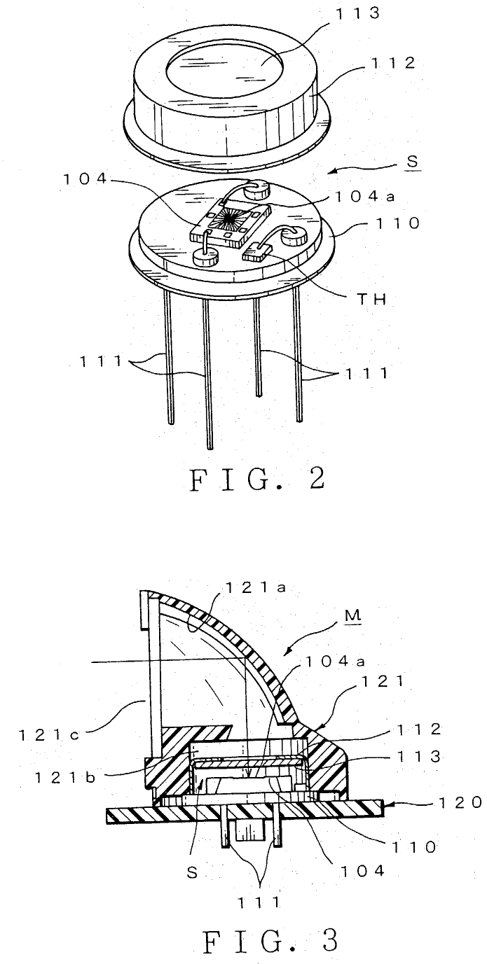

As shown in FIG. 3, an infrared sensor module M comprises a board 120, the infrared sensor S mounted on the board 120, and an infrared reflector 121 functioning as the condensing means which is fixed on the board 120 so that it covers the infrared sensor S.

The infrared reflector 121 is produced by plating the whole surface of the housing made of resin. The infrared reflector 121 comprises a concave mirror 121a; a recess 121b in which the infrared sensor S is placed; and an opening 121c formed facing the concave mirror 121a. The infrared sensor S is placed in the recess 121b so that an infrared-receiving section of the thermopile 104 is situated at a focal point of the concave mirror 121a. As for the housing made of resin described above, the plating may be carried out only for a portion, which constitutes the concave mirror 121a.

As shown in FIG. 1, the reference voltage Vref is obtained from the reference voltage source E in the reference voltage generation circuit 101 and applied to the temperature compensation circuit 102. Thereby, the reference voltage Vref is divided by the thermistor TH for detecting the ambient temperature in the temperature compensation circuit 102 and the resistance R2. The divided output voltage Vtho is applied to the non-inverting input terminal of the operational amplifier A1 of the first amplifier 103 by way of the resistance R3 and amplified by gain G1 of the operational amplifier A1.

At this time, the output voltage Vth of the operational amplifier A1 is expressed by

Vth=G1×Vref×R2/(R2+Rth), (1)

wherein Rth is a resistance value of the thermistor TH for detecting the ambient temperature.

The output voltage Vth is applied to the terminal of the thermopile 104 and to the inverting input terminal of the operational amplifier A2 in the second amplifier 105 by way of the resistance R6, acting as the voltage for shifting the operating point of the operational amplifier A2.

The temperature compensation of the thermopile 104 is carried out by applying the linearized output voltage Vtho from the temperature compensation circuit 102 to the input terminal of the thermopile 104 by way of the first amplifier 103.

The output voltage Vtho from the temperature compensation circuit 102 is expressed by

Vtho=Vref×R2/(R2+Rth). (2)

The temperature characteristic of the thermistor TH for detecting the ambient temperature is expressed by an exponential function. The output voltage characteristic can be linearized by computing the suitable resistance R2 within a range of temperature available for the infrared detection device.

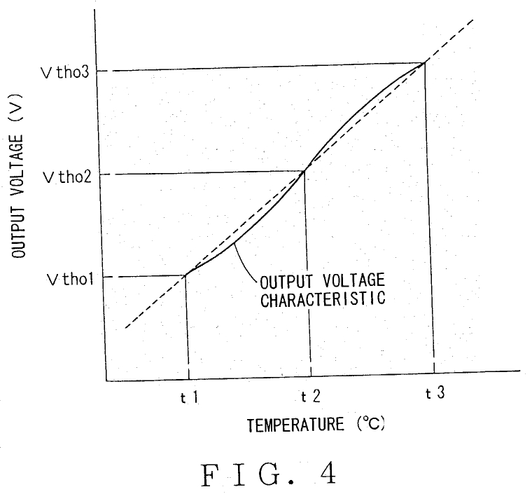

The resistance R2 is computed from the expression (2), a relationship of (Vtho2−Vtho1=Vtho3−Vtho2) among output voltage values Vtho1, Vtho3 and Vtho2, and resistance values Rth1, Rth3 and Rth2 of the thermistor TH at the lower limit temperature t1, upper limit temperature t3 and an intermediate temperature t2 between t1 and t3, respectively. The output voltage characteristic is shown in FIG. 4.

Since the resistance value Rth of the thermistor TH changes with the variation in the ambient temperature and the resistance variation is converted into the voltage variation to be inputted to the operational amplifier A1, therefore the output voltage Vtho changes in response to the variation in the ambient temperature, thereby a shifting component in the output of the thermopile 104 due to the variation in the ambient temperature is canceled out, thus the output of the thermopile 104 is temperature-compensated.

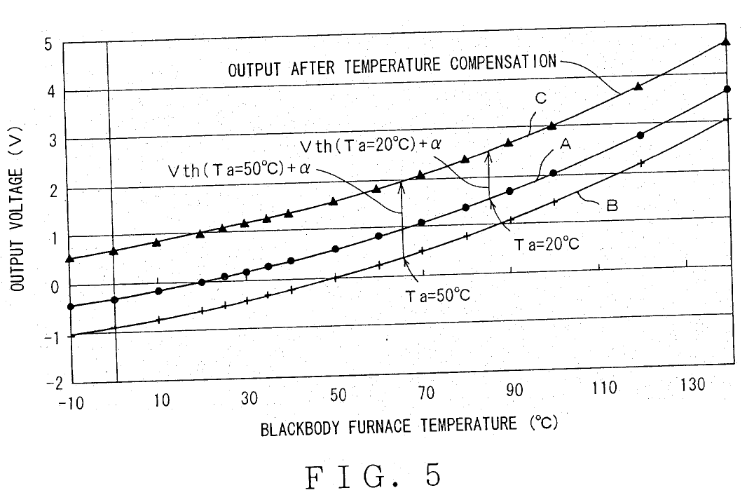

A reason why the output voltage Vtp of the thermopile 104 is temperature-compensated is as follows. FIG. 5 shows a temperature characteristic of the blackbody furnace temperature (° C.) versus the output voltage Vtp (V) as an example. For example, the output voltage Vtp without including the temperature compensation is expressed by a curve A and a curve B when the ambient temperature Ta=20° C. and Ta=50° C., respectively. As is seen from the figure, the curve shifts to the lower voltage-side as the ambient temperature Ta becomes higher.

On the other hand, when the output voltage is temperature-compensated (that is, when the temperature compensation circuit 102 is applied), the output voltage Vth from the first amplifier 103 is applied to the input terminal of the thermopile 104 and also applied to the inverting input terminal of the operational amplifier A2 in the second amplifier 105 by way of the resistance R6, thereby acting as a voltage for shifting the operating point of the operational amplifier A2. That is, the output Vout from the second amplifier 105 can be expressed as a curve C shown as “output after temperature compensation” in FIG. 5, in which the output voltage Vtp from the thermopile 104 is shifted by the magnitude of the output voltage Vth outputted from the first amplifier 103.

Thus, the temperature compensation circuit 102 enables that the output voltage Vtp from the thermopile 104, which tends to shift in response to the variation in the ambient temperature, is corrected to be a curve not depending upon the variation in the ambient temperature.

In the infrared sensor module M shown in FIG. 3, as shown by an arrow, the infrared radiated from a measuring object (not shown) enters the concave mirror 121a from the opening 121c of the infrared reflector 121, is condensed with the concave mirror 121a, passes through the infrared-transparent filter 113, and is guided to the infrared-receiving section 104a of the thermopile 104.

The thermopile 104 converts the infrared energy received by the infrared-receiving section 104a into the electric signal, thereby outputting the voltage according to the energy. The output voltage Vtp from the thermopile 104 is applied to the non-inverting input terminal of the operational amplifier A2 in the second amplifier 105 and amplified with the gain G2 of the operational amplifier A2 taking the operational reference voltage Vth (that is, the output voltage from the operational amplifier A1) as a reference.

As a result thereof, the output voltage Vout is obtained at the output terminal 106, which is connected to the output side of the operational amplifier A2. The output voltage Vout is expressed by

Vout=G2×Vtp+Vth. (3)

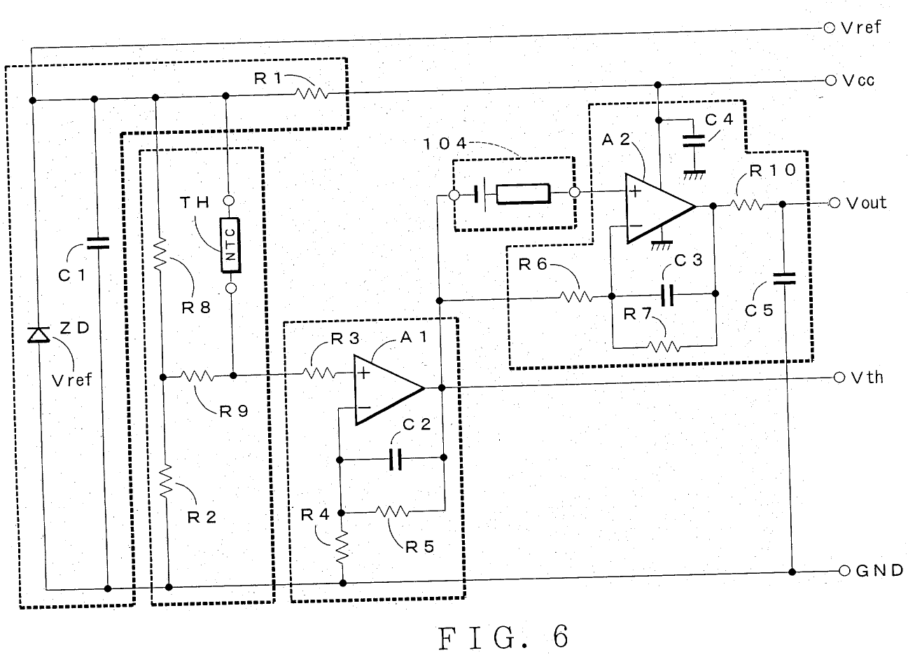

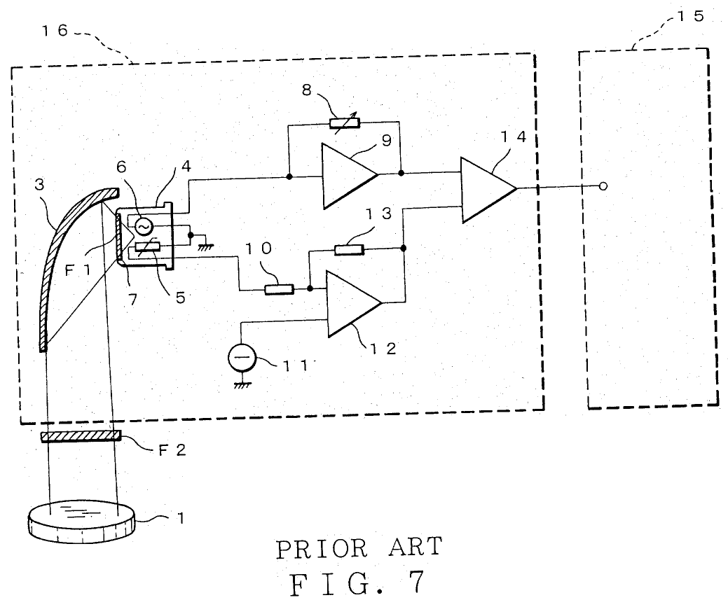

FIG. 6 is a circuit diagram illustrating an example of an actual constitution of the infrared detection device according to the present invention. In FIG. 6, the reference voltage source E shown in FIG. 1 is realized with a Zener diode ZD. A resistance R8 and a resistance R9 for linearizing the temperature characteristic are connected to the thermistor TH for detecting the ambient temperature in parallel and in series, respectively. Further, in the circuit shown in FIG. 6, capacitors C1-C5 and a resistance R10 are added besides the components, which constitute the circuit shown in FIG. 1. Furthermore, a NTC (Negative Temperature Coefficient)-type of a thermistor is used as the thermistor TH.

The infrared detection device according to the present invention has the following features:

(1) The temperature compensation circuit 102, which constitutes an infrared detection circuit, has an effect to remove the influence of the variation in the source voltage and the temperature drift by applying the reference voltage Vref to the thermistor TH for detecting the ambient temperature and the resistance R2. Therefore, precision output signal Vout corresponding to the infrared radiated from a measuring object is outputted from the second amplifier 105.

(2) As a circuit for compensating the ambient temperature dependency of the output voltage Vtp from the thermopile 104, the temperature compensation circuit 102 is provided and the output from the temperature compensation circuit 102 is amplified to be the voltage Vth, which is applied to the thermopile 104. That is, when the ambient temperature rises, the output voltage Vtp decreases, while when the ambient temperature falls, the output voltage Vtp increases. On the other hand, the output voltage Vth increases when the ambient temperature rises. By adding the output voltage Vth to the output voltage Vtp, a shifting component in the output voltage Vtp depending upon the variation in the ambient temperature can be canceled out.

(3) The temperature compensation with the temperature compensation circuit 102 is not carried out by computation with a difference amplification circuit as in a conventional device as shown in FIG. 7, but is carried out by varying the operational point (i.e., reference voltage) of the operational amplifier A2 in response to the variation in the ambient temperature.

(4) By linearizing the output voltage characteristic outputted from the temperature compensation circuit 102, the composition with a linear output characteristic outputted from the thermopile 104 can be possible.

(5) When the output voltage Vtp from the thermopile 104 is inverted (i.e., when the temperature of a measuring object is lower than the ambient temperature), two sources for the respective positive and negative outputs are necessary in case of an amplifier circuit taking zero volt as its reference, however, to the contrary, in the circuit according to the present invention, only one source for the positive output is needed. That is, since the voltage Vth is composed by including the voltage variation component due to the variation in temperature and the shifting component of the specific voltage, even when the output from the thermopile 104 is inverted into negative, it is possible that the output is outputted from the output terminal 106 as a positive voltage, thereby enabling precision detection for a wide range of infrared radiation dose (i.e., a wide range of temperature).

(6) Since the infrared detection device according to the present invention includes two operational amplifiers, therefore its constitution is simpler than that of the conventional device shown in FIG. 7 including three preamplifiers, thereby reducing the composition of the dispersion among the operating points and enabling precision temperature measurement. Further, since the infrared detection device according to the present invention includes only two operational amplifiers, which are fewer than those in the conventional device by one, therefore enabling the cost down.

The aforementioned preferred embodiments are described to aid in understanding the present invention and variations may be made by one skilled in the art without departing from the spirit and scope of the present invention.

What is claimed is:

1. An infrared detection device comprising:
reference voltage generation means for generating a specific reference voltage;
ambient temperature compensation means, to which a reference voltage from the reference voltage generation means is applied, for outputting a signal for compensating the ambient temperature;
first amplification means for amplifying the signal outputted from the ambient temperature compensation means;
infrared detection means, to which a signal outputted from the first amplification means is applied, for converting infrared radiation energy into an electric signal; and
second amplification means for amplifying a signal outputted from the infrared detection means.

2. The infrared detection device according to claim 1, wherein the ambient temperature compensation means comprises a thermistor for detecting the ambient temperature.

3. The infrared detection device according to claim 2, wherein the ambient temperature compensation means further comprises linearization means for linearizing a temperature characteristic of the thermistor for detecting the ambient temperature.

4. The infrared detection device according to claim 1, wherein the infrared detection means is a thermopile.

5. The infrared detection device according to claim 2, wherein the infrared detection means is a thermopile.

6. The infrared detection device according to claim 3, wherein the infrared detection means is a thermopile.

7. The infrared detection device according to claim 1, wherein the first and second amplification means include their respective operational amplifiers.

8. The infrared detection device according to claim 2, wherein the first and second amplification means include their respective operational amplifiers.

9. The infrared detection device according to claim 3, wherein the first and second amplification means include their respective operational amplifiers.

10. The infrared detection device according to claim 4, wherein the first and second amplification means include their respective operational amplifiers.

11. The infrared detection device according to claim 5, wherein the first and second amplification means include their respective operational amplifiers.

12. The infrared detection device according to claim 6, wherein the first and second amplification means include their respective operational amplifiers.

13. The infrared detection device as claimed in any one of claims 1-12 further comprising condensing means for condensing infrared radiated from a measuring object and guiding the condensed infrared to the infrared detection means.

14. The infrared detection device according to claim 13, wherein the condensing means is an infrared reflector comprising:
a concave mirror;
a recess in which an infrared sensor including the thermistor for detecting the ambient temperature and the thermopile is placed; and
an opening formed facing the concave mirror, which guides the infrared radiated from a measuring object to the concave mirror, wherein the infrared sensor is arranged so that an infrared-receiving section of the thermopile is situated at a focal point of the concave mirror.
